(19) United States
(12) Patent Application Publication
(10) Pub. No.: US 2026/0349403 A1
(43) Pub. Date: Nov. 5, 2026

(54) PROGRAMMABLE LOGIC CONTROLLER (PLC) UNSOLICITED MESSAGING CONFIGURATION IN INDUSTRIAL AUTOMATION ENVIRONMENTS

(71) Applicant: Rockwell Automation Technologies, Inc., Mayfield Heights, OH (US)

(72) Inventor: Marco Jendrock, Hannover (DE)

(21) Appl. No.: 19/198,911

(22) Filed: May 5, 2025

(51) Int. Cl. G05B 19/05

(52) U.S. Cl. CPC G05B 19/056; G05B 19/054

(57) ABSTRACT

Various embodiments include a system that comprises processing circuitry of an industrial automation environment. The processing circuitry provides a user interface that comprises functionality for facilitating unsolicited messaging from a Programmable Logic Controller (PLC) to a Human Machine Interface (HMI). The processing circuitry imports, based on a selection received via the user interface, an indication from the PLC that defines one or more data types generated by the PLC. The processing circuitry defines, based on another selection received via the user interface, an unsolicited message for the PLC to report the data of the one or more data types. The processing circuitry configures the PLC to transfer the unsolicited message that comprises the data of the one or more data types. The processing circuitry receives the unsolicited message from the PLC that comprises the data.

### TECHNICAL FIELD

Various implementations disclosed herein relate to industrial automation environments, and more specifically, to facilitating unsolicited messaging by Programmable Logic Controllers (PLCs) in industrial automation environments.

### BACKGROUND

Industrial automation environments comprise computing and mechanical systems configured to implement an industrial process. In industrial automation environments, control systems are used to drive various operations along an industrial line. Control programs are developed by programmers in the Integrated Design Environment (IDE) using design applications. The design applications comprise programming tools to design control programs for the industrial manufacturing environments. The control programs comprise logic to control industrial devices to carry out an industrial operation. The control programs are executed by control systems like Programmable Logic Controllers (PLCs) to drive the industrial assets, devices, and sensors in the industrial process. The industrial assets, devices, and sensors generate process data characterizing their performance and transfer the data for delivery to a Human Machine Interface (HMI) via the PLCs. The HMI provides a user interface that depicts the data to allow operators to assess the state of the industrial automation environment.

The industrial assets, devices, and sensors generate large amounts of data that characterize their operations and report this data to the PLC. The PLC may process this data to further characterize the operations of the assets, devices, and sensors. The PLC communicates the data for display on an HMI for human operators. The HMI comprises a computing device and display screen that allows a human operator to exert control over the industrial assets, devices, and sensors via the PLC based on the data. The PLC does not transfer the data unprompted. To obtain the data, the HMI must poll or otherwise request data delivery from the PLC. This increases the amount network signaling in the industrial automation environment. Given the large amount of data produced by the assets, devices, and sensors and the need to frequently (e.g., every millisecond) update the data displayed on the HMI, the requests transferred to the PLC from the HMI can become excessive. The excessive network signaling reduces the overall efficiency of the industrial automation environment. Unfortunately, industrial automation environments do effectively and efficiently facilitate data transfer from PLCs to HMIs.

### OVERVIEW

This Overview is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Various embodiments of the present technology generally relate to solutions for industrial automation environments. Some embodiments comprise a method. The method comprises providing, by processing circuitry of an industrial automation environment, a user interface that comprises functionality for facilitating unsolicited messaging from a Programmable Logic Controller (PLC) to a Human Machine Interface (HMI). The method further comprises importing, based on a first selection received in the user interface, an indication from the PLC that defines one or more data types generated by the PLC. The method further comprises defining, based on a second selection received in the user interface, an unsolicited message for the PLC to report data of the one or more data types. The method further comprises configuring the PLC to transfer the unsolicited message that comprises the data of the one or more data types. The method further comprises receiving the unsolicited message from the PLC that comprises the data.

Some embodiments comprise a system. The system comprises processing circuitry of an industrial automation environment. The processing circuitry provides a user interface that comprises functionality for facilitating unsolicited messaging from a PLC to an HMI. The processing circuitry imports, based on a first selection received in the user interface, an indication from the PLC that defines one or more data types generated by the PLC. The processing circuitry defines, based on a second selection received in the user interface, an unsolicited message for the PLC to report data of the one or more data types. The processing circuitry configures the PLC to transfer the unsolicited message that comprises the data of the one or more data types. The processing circuitry receives the unsolicited message from the PLC that comprises the data.

Some embodiments comprise one or more non-transitory computer readable storage media having program instructions stored thereon. The program instruction, when executed by a computing system, direct the computing system to perform operations. The operations comprise providing, by processing circuitry of an industrial automation environment, a user interface that comprises functionality for facilitating unsolicited messaging from a PLC to an HMI. The operations further comprise importing, based on a first selection received in the user interface, an indication from the PLC that defines one or more data types generated by the PLC. The operations further comprise defining, based on a second selection received in the user interface, an unsolicited message for the PLC to report data of the one or more data types. The operations further comprise configuring the PLC to transfer the unsolicited message that comprises the data of the one or more data types. The operations further comprise receiving the unsolicited message from the PLC that comprises the data.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an example of an industrial automation environment.

FIG. 2 illustrates an exemplary operation of the industrial automation environment.

FIG. 3 illustrates an example of a user interface.

FIG. 4 further illustrates the example of the user interface.

FIG. 5 further illustrates the example of the user interface.

FIG. 6 further illustrates the example of the user interface.

FIG. 7 illustrates an example of another user interface.

FIG. 8 illustrates an example of a computing device that may be used in accordance with various embodiments of the present technology.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

In a conventional industrial automation environment, a Programmable Logic Controller (PLC) executes a control program and transfers corresponding signaling to industrial devices to drive an industrial automated process. The devices generate data that characterizes their operations and report the data to the PLC. The PLC may further process the data before delivering the data to a Human Machine Interface (HMI). The HMI displays the received data to inform human operators of the current state of the industrial automation process. To obtain the data from the PLC, the HMI transfers a request to the PLC to trigger delivery of the data. Industrial automation environments are large and complex systems with numerous industrial assets, devices, and sensors. The numerous assets, devices, and sensors produce a correspondingly large amount of data. To provide an up-to-date view of the industrial automation process, the data sent to the HMI is typically updated at a high frequency (e.g., every millisecond). As such, the HMI transfers a large number of requests towards the PLC to trigger data delivery to provide an up-to-date view of the industrial automation process. The large amount of data in conjunction with the large number of requests heavily loads the communication network of the industrial automation environment. The heavy loading reduces the overall efficiency of the industrial automation environment.

To address the above problems in conventional industrial automation environments, various embodiments of the present technology relate to facilitating unsolicited messaging by PLCs. Processing circuitry of an industrial automation environment executes an HMI application provides a user interface with functionality for enabling unsolicited messaging from a PLC to an HMI (or other desired message endpoint). The HMI application imports an indication from the PLC that defines the data types produced by the PLC in response to a user selection received via the user interface. In response to receiving another user selection via the user interface, the HMI application defines an unsolicited message based on the data types produced by the PLC. For example, the HMI application may select a server Internet Protocol (IP) address and a set of server endpoints that correspond to the different data types to define the unsolicited message. The HMI application, or in some examples another application (e.g., a PLC application), configures to PLC to transfer the unsolicited message. For example, the HMI application may indicate a server IP address to the PLC to define the message path. Subsequently, the HMI application receives an unsolicited message from the PLC. The HMI application may display data included in the message (e.g., via an HMI faceplate), export the data to a cloud computing system of the industrial automation environment, and/or perform some other action on the received data. Enabling unsolicited messaging from the PLC to the HMI application eliminates the need for the HMI application to request data transfer from the PLC. This reduces the amount of network signaling within the industrial automation environment, thereby increasing the overall efficiency of the industrial automation environment. Now referring to the Figures.

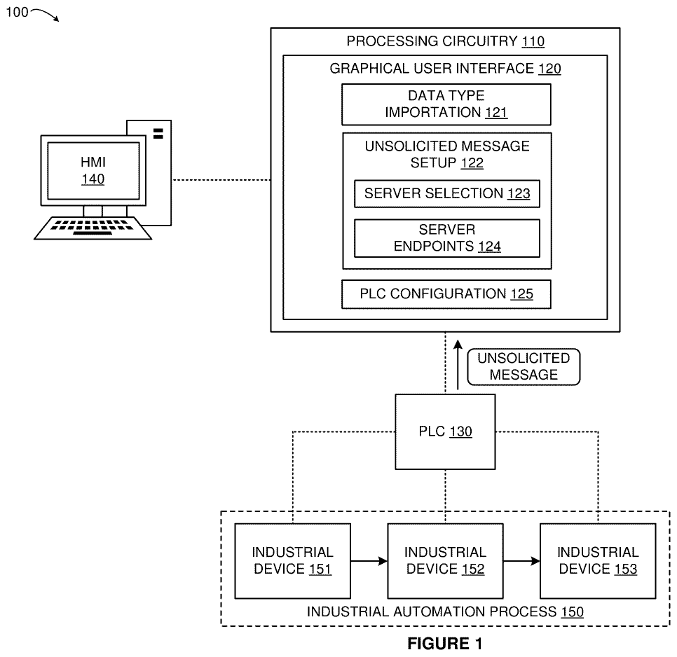

FIG. 1 illustrates an examples of industrial automation environment 100 to facilitate unsolicited messaging by PLCs. Industrial automation environment 100 performs services like factory automation, factory control, machine control, smart manufacturing, machine communication and organization, and the like. Industrial automation environment 100 comprises processing circuitry 110, PLC 130, HMI 140, and industrial automation process 150. Processing circuitry 110 comprises graphical user interface 120. Graphical user interface 120 comprises data type importation 121, unsolicited message setup 122, server selection 123, server endpoints 124, and PLC configuration 125 (referred to collectively as display elements 121-125). Industrial automation process 150 comprises industrial devices 151-153. Industrial automation environment 100 typically comprises additional components like Integrated Design Environments (IDEs), orchestration systems, and the like, however the additional components are omitted for clarity. In other examples, industrial automation environment 100 may include fewer or additional components than those illustrated in FIG. 1. Likewise, the illustrated components of industrial automation environment 100 may include fewer or additional components, assets, or connections than shown. Processing circuitry 110, PLC 130, and HMI 140 may be representative of a single computing apparatus or multiple computing apparatuses.

Various embodiments of industrial automation environment configuration and operation are described herein. In some examples, processing circuitry 110 provides graphical user interface 120. For example, processing circuitry 110 may execute an application (e.g., an HMI application) that causes processing circuitry 110 to render graphical user interface 120 on a display screen. Graphical user interface 120 comprises functionality to enable or otherwise facilitate unsolicited message reporting by PLC 130. As illustrated in FIG. 1, graphical user interface 120 comprises display elements for data type importation 121, unsolicited message setup 122, server selection 123, server endpoints 124, and PLC configuration 125. While illustrated as comprising a single graphical user interface, in some examples, processing circuitry 110 may provide multiple user interfaces that comprise different ones of display elements 121-125. For example, processing circuitry 110 may provide a first user interface comprising display elements 121-124 and display a second user interface comprising PLC configuration 125.

Data type importation 121 comprises functionality to drive processing circuitry 110 to import the data types generated by PLC 130. Exemplary data types include byte arrays, structured data, User Defined Type (UDT) data, and the like. The data types generated by PLC 130 may be referred to as tags. Unsolicited message setup 122 comprises functionality to drive processing circuitry 110 to be able to receive the unsolicited message from PLC 130. For example, unsolicited message setup 122 may configure processing circuitry 110 to listen for the unsolicited message. Server selection 123 comprises functionality to drive processing circuitry 110 to select a message destination for the unsolicited message. For example, server selection 123 may indicate a user defined IP address of the destination server. The destination server may comprise HMI 140, processing circuitry 110, a server in a cloud computing system (not illustrated), and the like. Server endpoints 124 comprises functionality to drive processing circuitry 110 to define the endpoints in the selected destination server. For example, server endpoints 124 may define one or more tables in the destination server to write data received in the unsolicited message. The one or more tables may correspond to the data types produced by PLC 130. PLC configuration 125 comprises functionality to drive processing circuitry 110 to configure PLC 130 to transfer the unsolicited message to the selected destination server and to write the data in the unsolicited message to the server endpoints. For example, PLC configuration 125 may direct processing circuitry 110 to indicate the IP address of the destination server to PLC 130.

In some examples, processing circuitry 110 executes an HMI application and responsively renders graphical user interface 120 on a display screen. Data type importation 121 receives a user input and directs processing circuitry 110 to import program tags from PLC 130. The program tags (e.g., in the ladder logic executed by PLC 130 to control industrial automation process 150) indicate the type of data generated PLC 130 while controlling industrial automation process 150. Processing circuitry 110 transfers a request to retrieve the program tags to PLC 130 and PLC 130 indicates the program tags to processing circuitry 110. In this example, PLC 130 implements program tags to generate a byte array and a structured UDT. Unsolicited message setup 122 receives a user input and directs processing circuitry 110 to listen (e.g., be able to accept) unsolicited messages transferred by PLC 130 that comprise the data types identified by the imported data tags. Server selection 123 receives a user input defining the IP address of HMI 140 and server selection 123 provides the IP address to processing circuitry 110. Server endpoints 124 receives an input defining a number of endpoints in HMI 140 that corresponds to the data types produced by PLC 130. PLC configuration 125 receives an input and directs processing circuitry 110 to inform PLC 130 to route unsolicited messages to the IP address of HMI 140 and to write data included in the message to the corresponding server endpoints. Processing circuitry 110 directs PLC 130 based on the user input received by PLC configuration 125.

Subsequently, PLC 130 executes a control program and transfers signaling to industrial devices 151-153 to drive industrial automation process 150. Industrial devices 151-153 generate raw data characterizing their operations and report the data to PLC 130. PLC 130 processes the data to generate a byte array and a structured UDT table. PLC 130 may generate different data types in other examples. PLC 130 generates an unsolicited message comprising the byte array and the UDT table and transfers the unsolicited message to HMI 140 via processing circuitry 110 based on the IP address for HMI 140. HMI 140 writes the byte array and structured UDT table to their corresponding server endpoints. HMI 140 displays the received data on its display screen for review by an operator. In some examples, the operator may wish to affect the operation of PLC 130 based on the displayed data. For example, the operator may wish to pause the operation of PLC 130 based on an anomaly depicted in the data. Processing circuitry 110 may receive a user input via HMI 140 that comprising signaling to affect PLC 130. Processing circuitry 110 may then transfer the signaling to PLC 130 affect the operation of PLC 130.

Advantageously, industrial automation environment 100 effectively enables unsolicited message by a PLC. Moreover, industrial automation environment 100 efficiently reduces the amount of network signaling by eliminating the need to poll the PLC to enable data transfer.

Processing circuitry 110 is representative of a computing system that hosts an application(s) to facilitate PLC unsolicited messaging. Exemplary computing systems comprise virtualized computing systems, data centers, server farms, cloud computing networks, hybrid cloud networks, and the like. Processing circuitry 110 renders graphical user interface 120 on a display screen associated with processing circuitry 110. The display screen may be local (e.g., at the location of processing circuitry 110) or remote (e.g., on the computing device that renders HMI 140). Processing circuitry 110, PLC 130, HMI 140, and industrial devices 151-153 communicate over various links that use metallic links, glass fibers, radio channels, or some other communication media. The links use industrial ethernet, Common Industrial Protocol (CIP), virtual switching, inter-processor communication, bus interfaces, and/or some other data communication protocol.

Graphical user interface 120 is representative of a display that provides a graphical representation of the application hosted by processing circuitry 110. Display elements 121-125 of graphical user interface 120 comprise user selectable options that allow the user to interact with the application and drive the operation of processing circuitry 110. Graphical user interface 120 may be displayed on a display screen of a computer, a mobile device, a kiosk, a touchscreen device, or some other type of computing device (e.g., processing circuitry 110) as described herein. A user may interact with graphical user interface 120 via inputs like mouse clicks, keyboard inputs, touchscreen inputs, drag-and-drop selections, and the like.

PLC 130 may comprise one or more computing devices configured to implement control programs to control industrial automation process 150. For example, PLC 130 may receive and execute ladder logic of a control program and transfer corresponding control signaling to drive industrial automation process 150. Industrial devices 151-153 operate in response to the control signaling. The control signaling drives actuators or other types of control element in industrial devices 151-153. For example, the control signaling may correspond to an actuator setting that sets a motor speed in industrial device 151 to a desired value. For example, the control signaling may correspond to an actuator setting in industrial device 152 that sets a pump valve to an open position.

HMI 140 is representative of one or more computing devices configured to illustrate the operating conditions of PLC 130 and receive user inputs to affect the operations of PLC 130. Although HMI 331 is illustrated as a personal computing device, HMI 331 may comprise a server computer, mobile device, kiosk, touchscreen device, faceplate, or another types of computing device capable of performing the functions described herein. For example, HMI 140 may obtain structured data (e.g., a UDT table) received by processing circuitry 110 in the unsolicited message, display the structured data, receive a user input to affect the operation of PLC based on the data, and transfer signaling to PLC 130 (e.g., via processing circuitry 110) based on the user input to affect the operation of PLC 130. The signaling may cause PLC 130 to increase the rate of industrial automation process 150, pause or decrease the rate of industrial automation process 150, and/or perform some other type of action to alter industrial automation process 150.

Industrial automation process 150 is representative of a manufacturing process, chemical production process, food processing process, energy generation process, or any other type of industrial process. Industrial automation process 150 may comprises a process for manufacturing goods but may also comprise processes occurring within a utility plant (e.g., an electrical power plant), research or laboratory facility (e.g., a sample testing or processing facility), processes occurring within a food processing facility (e.g., a cattle processing plant), processes occurring within a chemical processing facility (e.g., petroleum refinery), or any other suitable industrial automated environment. Industrial devices 151-153 comprise factory or industrial machinery or manufacturing equipment such as conveyor belts or other conveyance mechanisms, robotic devices or other automated or programmable devices, packaging devices including boxing, capping, and sealing equipment, processing equipment, mixers, filling stations, quality control equipment, pumps, compressors, heat exchanges, centrifuges, turbines, mills, conveyers, filters, generators, reactors, distillation systems, food processing systems, and/or other devices associated with manufacturing or other industrial processes. Industrial devices 151-153 may comprise subcomponents like motors, actuators, valves, electrical circuitry, processing circuitry, storage circuitry, transceivers, machined parts, and the like.

Processing circuitry 110, PLC 130, HMI 140, and industrial devices 151-153 communicate over various communication links using communication technologies like industrial ethernet, CIP, Institute of Electrical and Electronic Engineers (IEEE) 802.3 (Ethernet), IEEE 802.11 (WiFi), Internet Protocol (IP), EtherNet/IP, Bluetooth, Time Division Multiplex (TDM), Data Over Cable System Interface Specification (DOCSIS), General Packet Radio Service Transfer Protocol (GTP), and/or some other type of wireline and/or wireless networking protocol. The communication links comprise metallic links, glass fibers, radio channels, or some other communication media. The links use Ethernet, WiFi, virtual switching, inter-processor communication, bus interfaces, and/or some other data communication protocols.

Processing circuitry 110, PLC 130, HMI 140, and industrial devices 151-153 comprise microprocessors, software, memories, transceivers, bus circuitry, and the like. The microprocessors comprise Central Processing Units (CPUs), Graphical Processing Units (GPUs), Digital Signal Processors (DSPs), Application-Specific Integrated Circuits (ASICs), Field Programmable Gate Arrays (FPGAs), analog computing circuits, and/or the like. The memories comprise Random Access Memory (RAM), flash circuitry, Hard Disk Drives (HDDs), Solid State Drives (SSDs), Non-Volatile Memory Express (NVMe) SSDs, and/or the like. The memories store software like operating systems, management applications, HMI applications, PLC applications, user applications, networking applications, control applications, security applications, machine learning applications, orchestration applications, and the like. The microprocessors retrieve the software from the memories and execute the software to drive the operation of industrial automation environment 100 as described herein.

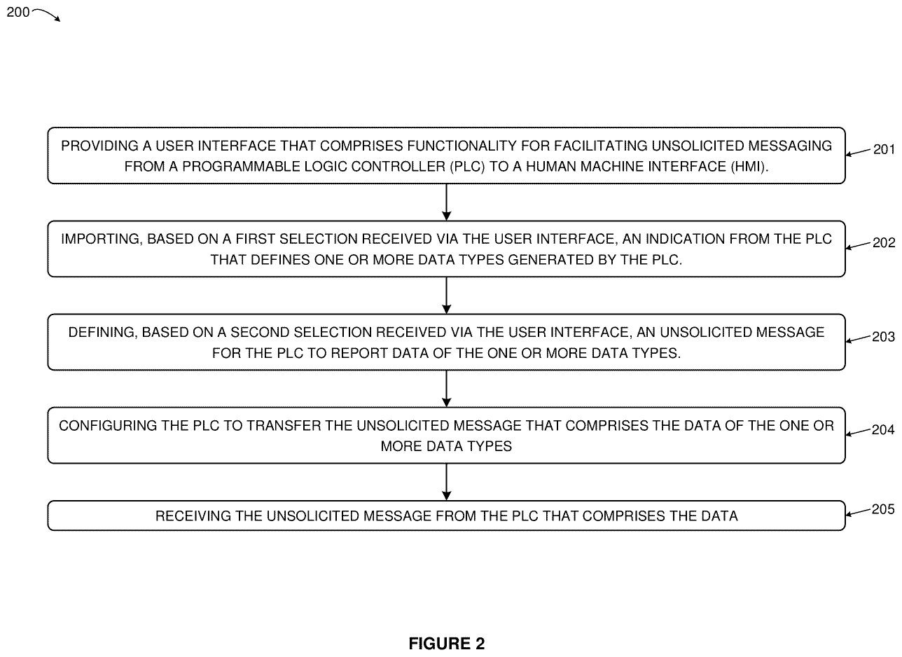

In some examples, industrial automation environment 100 implements process 200 illustrated in FIG. 2. It should be appreciated that the structure and operation of industrial automation environment 100 may differ in other examples.

FIG. 2 illustrates process 200. Process 200 comprises an exemplary operation of industrial automation environment 100 to facilitate unsolicited messaging from a PLC (e.g., PLC 130). Process 200 may vary in other examples. The operations of process 200 comprise providing a user interface that comprises functionality for facilitating unsolicited messaging from a PLC to an HMI (e.g., HMI 140) (step 201). The operations further comprise importing, based on a first selection received via the user interface, an indication from the PLC that defines one or more data types generated by the PLC (step 202). The operations further comprise defining, based on a second selection received via the user interface, an unsolicited message for the PLC to report data of the one or more data types (step 203). The operations further comprise configuring the PLC to transfer the unsolicited message that comprises the data of the one or more data types (step 204). The operations further comprise receiving the unsolicited message from the PLC that comprises the data (step 205).

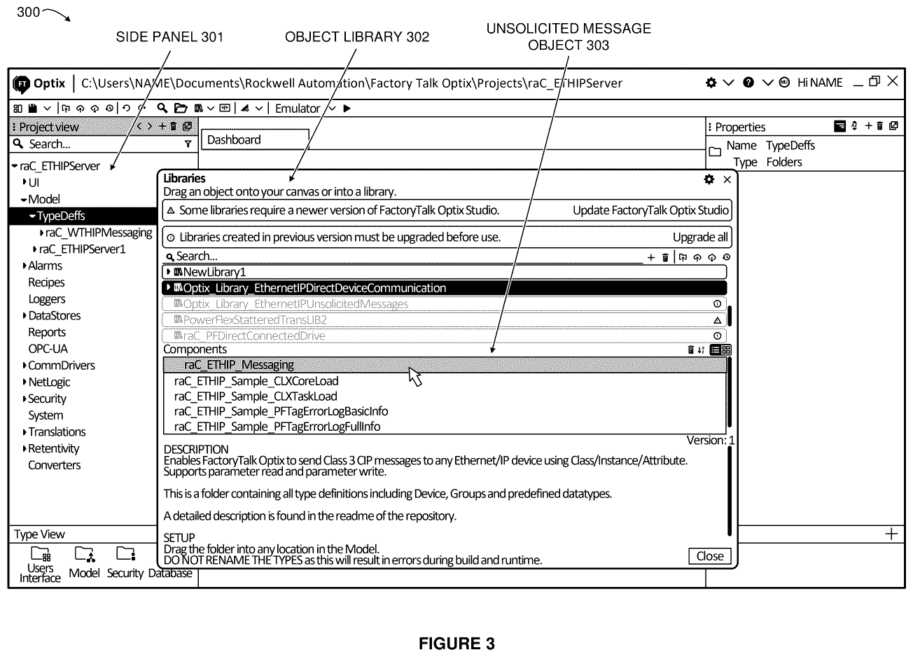

FIG. 3 illustrates an example of user interface 300. User interface 300 comprises an example of graphical user interface 120 illustrated in FIG. 1, however graphical user interface 120 may differ. User interface 300 comprises side panel 301, object library 302, and unsolicited message object 303. Side panel 301, object library 302, and unsolicited message object 303, and/or the other display elements included in user interface 300 may differ in other examples. While side panel 301, object library 302, and unsolicited message object 303 are depicted at specific locations within user interface 300, the locations of panel 301, object library 302, and unsolicited message object 303 may differ in other examples.

In some examples, user interface 300 is representative of a display that provides a graphical representation of an HMI application to communicatively couple PLCs with HMI faceplates in an industrial automation environment. User interface 300 may be generated on a display screen for viewing or use by an operator or similar user by a user computer or cloud computing system of an industrial automation environment. For example, user interface 300 may be displayed on a display screen of a computer, a mobile device, a kiosk, a touchscreen device, or some other type of computing device as described herein. A user may interact with the HMI application via user interface 300 using inputs like mouse clicks, keyboard inputs, touchscreen inputs, and the like to enable the HMI application to receive unsolicited messages from a PLC. The HMI application may receive unsolicited messages from a PLC that comprise data generated by industrial assets, sensors, and/or devices, and transfer the data for display on an HMI faceplate, export the data to a cloud system, and/or perform some other operation on the received data.

Side panel 301 comprises a set of selectable options that allow the user to access the functionality of the HMI application. For example, a user may select one of the options depicted in side panel 301 to render object library 302 in user interface 300. Object library 302 comprises a library of objects, including unsolicited message object 303, that may be added to user interface 300. The user may drag and drop objects from object library 302 into the model option of side panel 301 to add the object to user interface 300. Each object comprises code to perform one or more functions. For example, unsolicited message object 303 may comprise code that enables the HMI application rendering user interface 300 to receive unsolicited messages from a PLC. To add unsolicited message object 303 to the HMI application, a user may drag-and-drop (or use another suitable selection method) unsolicited message object 303 (labeled raC_ETHIP_Messaging in FIG. 3) from object library 302 into the model object of side panel 301. Once added to the model, the user may then configure unsolicited message object 303 to define the unsolicited message path and the server endpoints to write the data included in the unsolicited message.

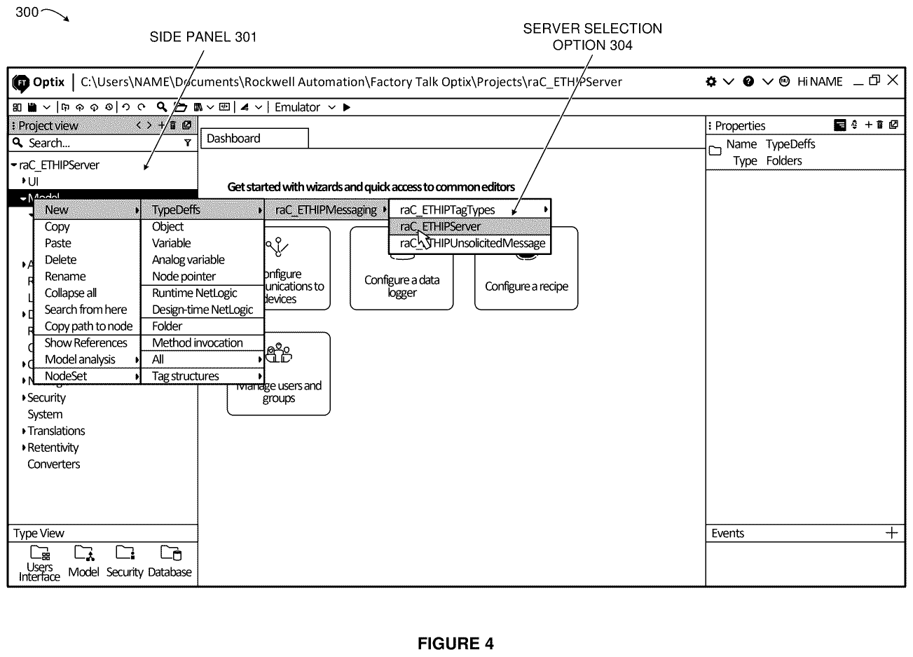

FIG. 4 further illustrates user interface 300. User interface 300 now comprises server selection option 304 and omits object library 302 and unsolicited message object 303. Server selection option 304 comprises and example of unsolicited message setup 122 and server selection 123 illustrated in FIG. 1, however unsolicited message setup 122 and server selection 123 may differ. In some examples, after adding unsolicited message object 303 to the model option, the user right-clicks the model option in side panel 301 to render server selection option 304. The user may left click server selection option 304 to add a server (labeled raC_ETHIPServer) to the model. The server is representative of the unsolicited message destination. For example, the server may comprise a device rendering an HMI faceplate, a server in a cloud-computing system associated with the industrial automation environment, or some other message destination. Once added to the model, the user may define the IP address of the server to set up the unsolicited message path.

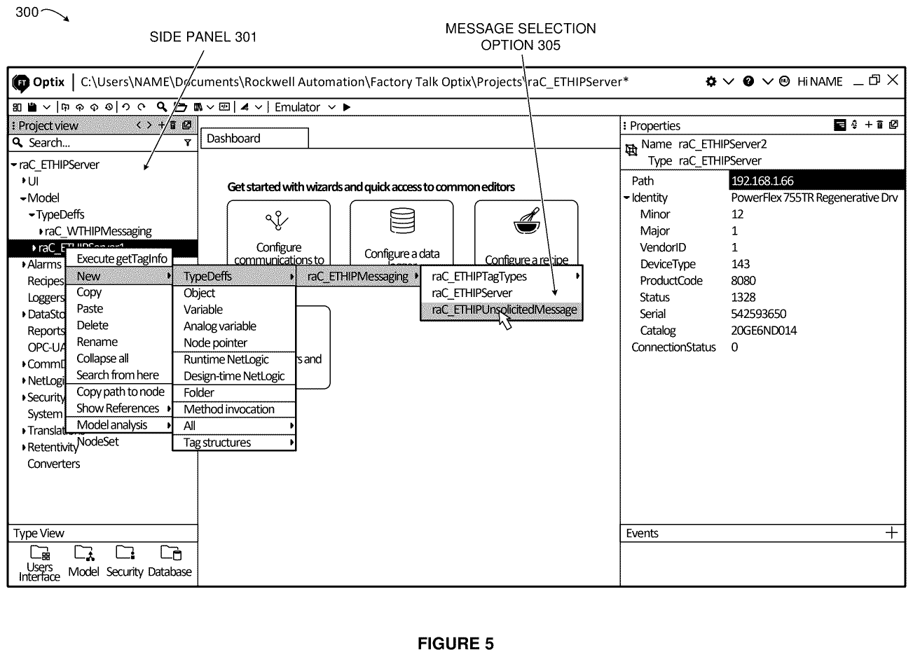

FIG. 5 further illustrates user interface 300. User interface 300 now comprises message selection option 305 and omits server selection option 304. Message selection option 305 comprises and example of unsolicited message setup 122 and illustrated in FIG. 1, however unsolicited message setup 122 may differ. In some examples, after selecting a server via server selection option 304, the user right-clicks the raC_ETHIPServer option added to the model in side panel 301 to add an unsolicited message (labeled raC_ETHIPUnsolicitedMessage) to the model. The unsolicited message, when added to the model, instructs the HMI application rendering user interface 300 to listen for unsolicited messages transferred by the PLC for delivery to the server. Once added to the model, the user may import the tags used by the PLC to define the data types included in the unsolicited message.

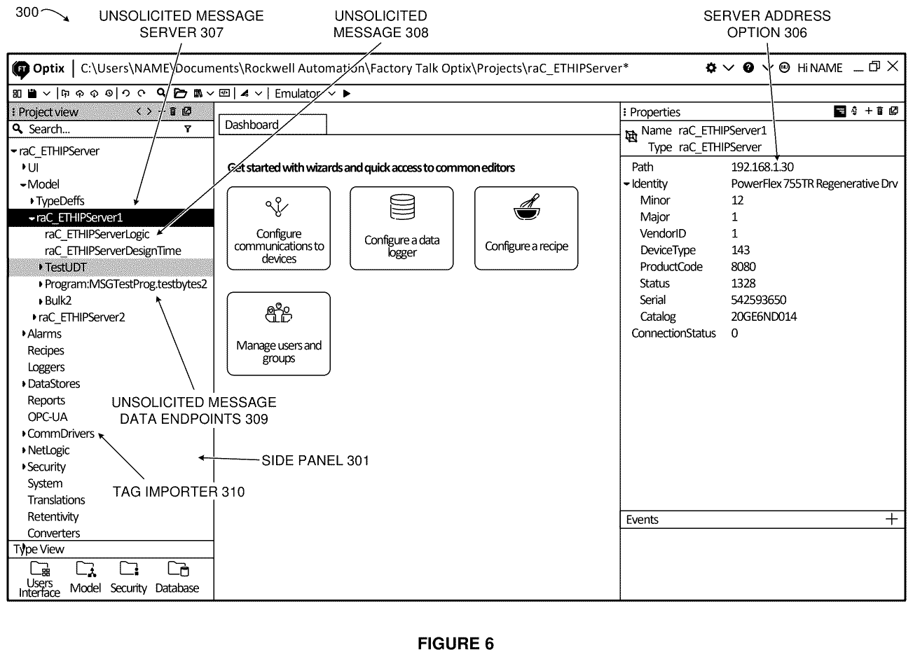

FIG. 6 further illustrated user interface 300. User interface 300 now comprises server address option 306, unsolicited message server 307, unsolicited message 308, unsolicited message data endpoints 309, and tag importer 310 and omits message selection option 305. Server address option 306 comprises an example of server selection 123 illustrated in FIG. 1, however server selection 123 may differ. Unsolicited message data endpoints 309 comprises an example of server endpoints 124 illustrated in FIG. 1, however server endpoints 124 may differ. Tag importer 310 comprises an example of data type importation 121 illustrated in FIG. 1, however data type importation 121 may differ. In some examples, unsolicited message server 307 and unsolicited message 308 are added to the model in side panel 301 in response to user selections of server selection option 304 and message selection option 305. User interface 300 renders server address option 306 to define the IP address of the server added to the model. For example, server address option 306 may comprise a text box allowing a user to type the IP address of the intended message destination. The HMI application may then route unsolicited messages received from the PLC to the server based on the IP address. Tag importer 310 (labeled CommDrivers in FIG. 6) is a selectable option in side panel 301 that allows the user to import the control program tags executed by the PLC to generate message data. The tags indicate the type (e.g., byte arrays, structured data, UDT, etc.) of data generated by the PLC. For example, the user may right-click tag importer 310 to import tags from the PLC. The user defines unsolicited message data endpoints 309 (labeled TestUDT, Program:MSGTestProg.testbytes2, and Bulk2 in FIG. 6) based on the imported tags. Unsolicited message data endpoints 309 represent the endpoints in the server (e.g., data tables) where the PLC writes data to. Each of unsolicited message data endpoints 309 corresponds to one or more of the imported program tags. Once the endpoints and server IP address are defined, the HMI application is prepared to receive unsolicited messages from the PLC.

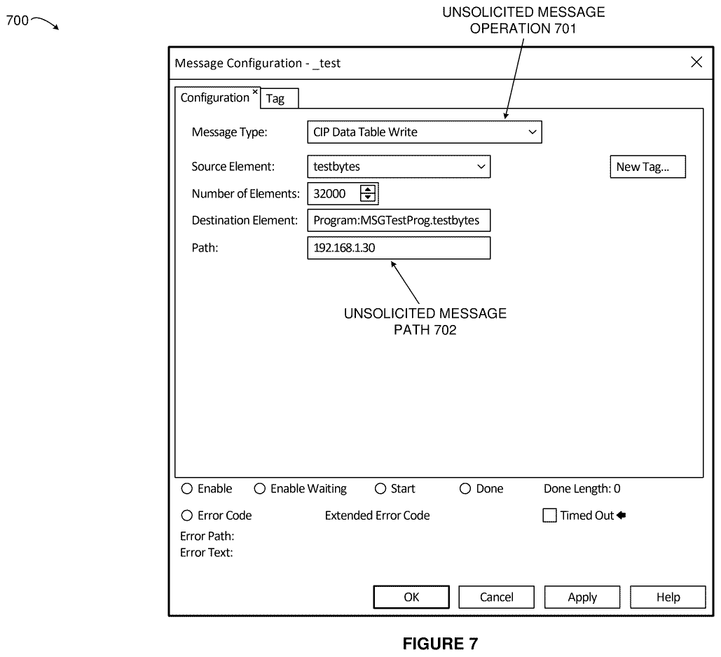

FIG. 7 illustrates an example of user interface 700. User interface 700 comprises an example of graphical user interface 120 illustrated in FIG. 1, however graphical user interface 120 may differ. User interface 700 comprises unsolicited message operation 701 and unsolicited message path 702. Unsolicited message operation 701 and unsolicited message path 702 comprise examples of PLC configuration 125 illustrated in FIG. 1, however PLC configuration 125 may differ. Unsolicited message operation 701, unsolicited message path 702, and/or the other display elements included in user interface 700 may differ in other examples. While unsolicited message operation 701 and unsolicited message path 702 are depicted at specific locations within user interface 700, the locations of unsolicited message operation 701 and unsolicited message path 702 may differ in other examples. While illustrated as begin separate from user interface 300, in some examples, user interface 300 and user interface 700 may comprise a single user interface.

In some examples, user interface 700 is representative of a display that provides a graphical representation of a PLC application to configure PLCs to transfer unsolicited messages to an HMI application (e.g., the application executed to render user interface 300) in an industrial automation environment. User interface 700 may be generated on a display screen for viewing or use by an operator or similar user by a user computer or cloud computing system of an industrial automation environment. For example, user interface 700 may be displayed on a display screen of a computer, a mobile device, a kiosk, a touchscreen device, or some other type of computing device as described herein. A user may interact with the PLC application via user interface 700 using inputs like mouse clicks, keyboard inputs, touchscreen inputs, and the like to configure the PLC to transfer unsolicited messages to the HMI application.

Unsolicited message operation 701 comprises a drop-down menu with a set of options to select a data processing operation for the PLC. For example, a user may click unsolicited message operation 701 to cause user interface 700 to display a drop-down menu and the user may select one of the options from the drop-down menu to define the data processing operation for the PLC. In this example, the user has selected CIP Data Table Write. This option configures the PLC to write data included in the unsolicited message to endpoints in the server. In other examples, the user may select a different data processing operation for the PLC. Unsolicited message path 702 comprises a text box that allows the user to type the IP address of the server selected in user interface 300. This configures the PLC to transfer unsolicited messages for delivery to the intended message destination based on the IP address.

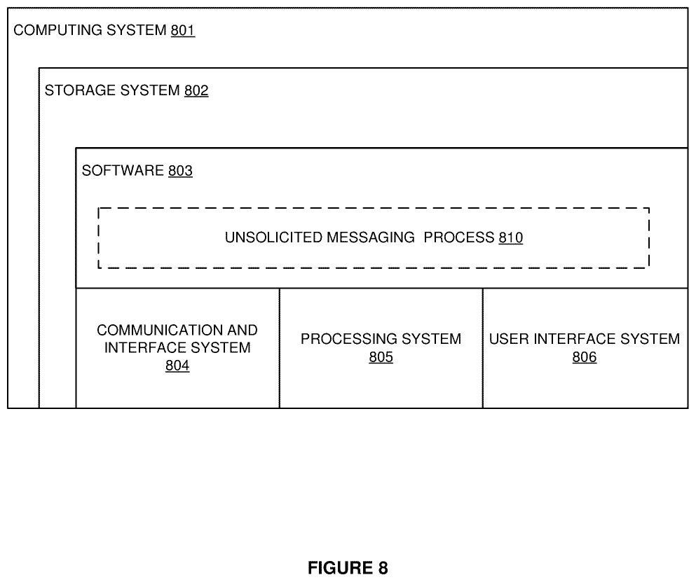

FIG. 8 illustrates computing system 801 according to an implementation of the present technology. Computing system 801 is representative of any system or collection of systems with which the various operational architectures, processes, scenarios, and sequences disclosed herein for facilitating unsolicited messaging in industrial automation environments. For example, computing system 801 may be representative of processing circuitry 110, PLC 130, HMI 140, the computing device providing user interface 300, the computing device providing user interface 700, and/or any other computing device contemplated herein. Computing system 801 may be implemented as a single apparatus, system, or device or may be implemented in a distributed manner as multiple apparatuses, systems, or devices. Computing system 801 includes, but is not limited to, storage system 802, software 803, communication interface system 804, processing system 805, and user interface system 806. Processing system 805 is operatively coupled with storage system 802, communication interface system 804, and user interface system 806.

Processing system 805 loads and executes software 803 from storage system 802. Software 803 includes unsolicited messaging process 810, which is representative of any of the processes to facilitate unsolicited messaging with respect to the preceding Figures, including but not limited to the user interface generation, unsolicited message configuration, and unsolicited message handling processes described with respect to the preceding Figures. For example, unsolicited messaging process 810 may be representative of process 200 illustrated in FIG. 2. When executed by processing system 805 to facilitate unsolicited messaging is an industrial automation environment, software 803 directs processing system 805 to operate as described herein for at least the various processes, operational scenarios, and sequences discussed in the foregoing implementations. Computing system 801 may optionally include additional devices, features, or functionality not discussed for purposes of brevity.

Processing system 805 may comprise a micro-processor and other circuitry that retrieves and executes software 803 from storage system 802. Processing system 805 may be implemented within a single processing device but may also be distributed across multiple processing devices or sub-systems that cooperate in executing program instructions. Examples of processing system 805 include general purpose CPUs, GPUs, DSPs, ASICs, FPGAs, and logic devices, as well as any other type of processing device, combinations, or variations thereof.

Storage system 802 may comprise any computer readable storage media readable by processing system 805 and capable of storing software 803. Storage system 802 may include volatile, nonvolatile, removable, and/or non-removable media implemented in any method or technology for storage of information, such as computer readable instructions, data structures, program modules, or other data. Examples of storage media include RAM, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 802 may also include computer readable communication media over which at least some of software 803 may be communicated internally or externally. Storage system 802 may be implemented as a single storage device but may also be implemented across multiple storage devices or sub-systems co-located or distributed relative to each other. Storage system 802 may comprise additional elements, such as a controller, capable of communicating with processing system 805 or possibly other systems.

Software 803 (including unsolicited messaging process 810) may be implemented in program instructions and among other functions may, when executed by processing system 805, direct processing system 805 to operate as described with respect to the various operational scenarios, sequences, and processes illustrated herein. For example, software 803 may include program instructions for retrieving program tags from a PLC, defining an unsolicited message based on the program tags, and configuring the PLC to transfer the unsolicited message as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 803 may include additional processes, programs, or components, such as operating system software, virtualization software, or other application software. Software 803 may also comprise firmware or some other form of machine-readable processing instructions executable by processing system 805.

In general, software 803 may, when loaded into processing system 805 and executed, transform a suitable apparatus, system, or device (of which computing system 801 is representative) overall from a general-purpose computing system into a special-purpose computing system customized to facilitate unsolicited messaging as described herein. Indeed, encoding software 803 on storage system 802 may transform the physical structure of storage system 802. The specific transformation of the physical structure may depend on various factors in different implementations of this description. Examples of such factors may include, but are not limited to, the technology used to implement the storage media of storage system 802 and whether the computer-storage media are characterized as primary or secondary storage, as well as other factors.

For example, if the computer readable storage media are implemented as semiconductor-based memory, software 803 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 804 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and an extended discussion of them is omitted for the sake of brevity.

While some examples provided herein are described in the context of computing devices for facilitating unsolicited messaging, it should be understood that the systems and methods described herein are not limited to such embodiments and may apply to a variety of other industrial automation environments and their associated systems. As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

What is claimed is:

1. A method comprising:
providing, by processing circuitry of an industrial automation environment, a user interface that comprises functionality for facilitating unsolicited messaging from a Programmable Logic Controller (PLC) to a Human Machine Interface (HMI);
importing, based on a first selection received in the user interface, an indication from the PLC that defines one or more data types generated by the PLC;
defining, based on a second selection received in the user interface, an unsolicited message for the PLC to report data of the one or more data types;
configuring the PLC to transfer the unsolicited message that comprises the data of the one or more data types; and
receiving the unsolicited message from the PLC that comprises the data.

2. The method of claim 1 further comprising displaying the data received in the unsolicited message on the HMI.

3. The method of claim 1 further comprising transferring the data received in the unsolicited message to a cloud computing system.

4. The method of claim 1 wherein defining the unsolicited message for the PLC comprises defining a server Internet Protocol (IP) address and one or more server endpoints that correspond to the one or more data types.

5. The method of claim 1 wherein configuring the PLC to transfer the unsolicited message comprises indicating a server Internet Protocol (IP) address to transfer the unsolicited message to and one or more server endpoints that correspond to the one or more data types to write the data to.

6. The method of claim 1 further comprising transferring a command to affect the operation of the PLC based on the data.

7. The method of claim 1 wherein the one or more data types comprise one or more of structured data or a User Defined Data Type (UDT).

8. A system comprising:
processing circuitry of an industrial automation environment configured to:
provide a user interface that comprises functionality for facilitating unsolicited messaging from a Programmable Logic Controller (PLC) to a Human Machine Interface (HMI);
import, based on a first selection received in the user interface, an indication from the PLC that defines one or more data types generated by the PLC;
define, based on a second selection received in the user interface, an unsolicited message for the PLC to report data of the one or more data types;
configure the PLC to transfer the unsolicited message that comprises the data of the one or more data types; and
receive the unsolicited message from the PLC that comprises the data.

9. The system of claim 8 wherein the processing circuitry is further configured to display the data received in the unsolicited message on the HMI.

10. The system of claim 8 wherein the processing circuitry is further configured to transfer the data received in the unsolicited message to a cloud computing system.

11. The system of claim 8 wherein the processing circuitry is configured to define a server Internet Protocol (IP) address and one or more server endpoints that correspond to the one or more data types to define the unsolicited message for the PLC.

12. The system of claim 8 wherein the processing circuitry is configured to indicate a server Internet Protocol (IP) address to transfer the unsolicited message to and one or more server endpoints that correspond to the one or more data types to write the data to configure the PLC to transfer the unsolicited message.

13. The system of claim 8 wherein the processing circuitry is further configured to transfer a command to affect the operation of the PLC based on the data.

14. The system of claim 8 wherein the one or more data types comprise one or more of structured data or a User Defined Data Type (UDT).

15. One or more non-transitory computer readable storage media having program instructions stored thereon, wherein the program instruction, when executed by a computing system, direct the computing system to perform operations, the operations comprising:
providing a user interface of an industrial automation environment that comprises functionality for facilitating unsolicited messaging from a Programmable Logic Controller (PLC) to a Human Machine Interface (HMI);
importing, based on a first selection received via the user interface, an indication from the PLC that defines one or more data types generated by the PLC;
defining, based on a second selection received via the user interface, an unsolicited message for the PLC to report data of the one or more data types;
configuring the PLC to transfer the unsolicited message that comprises the data of the one or more data types; and
receiving the unsolicited message from the PLC that comprises the data.

16. The computer readable storage media of claim 15 wherein the operations further comprise displaying the data received in the unsolicited message on the HMI.

17. The computer readable storage media of claim 15 wherein the operations further comprise transferring the data received in the unsolicited message to a cloud computing system.

18. The computer readable storage media of claim 15 wherein defining the unsolicited message for the PLC comprises defining a server Internet Protocol (IP) address and one or more server endpoints that correspond to the one or more data types.

19. The computer readable storage media of claim 15 wherein configuring the PLC to transfer the unsolicited message comprises indicating a server Internet Protocol (IP) address to transfer the unsolicited message to and one or more server endpoints that correspond to the one or more data types to write the data to.

20. The computer readable storage media of claim 15 wherein the one or more data types comprise one or more of structured data or a User Defined Data Type (UDT).
